(19) United States
(12) Patent Application Publication
(10) Pub. No.: US 2012/0072550 A1
(43) Pub. Date: Mar. 22, 2012

(54) METHOD AND COMPUTER SERVER FOR SELECTING INFORMATION IN THE INTERNET AND USING SAID INFORMATION IN A SHARED WEBSITE

(76) Inventor: Raisa Ivanovna Anufrieva, Saint Petersburg (RU)

(21) Appl. No.: 13/322,155

(22) PCT Filed: May 26, 2010
(86) PCT No.: PCT/RU10/00288

§ 371 Date: Nov. 23, 2011

(30) Foreign Application Priority Data
May 27, 2009 (RU) 2009121481

(51) Int. Cl. G06F 15/16

(52) U.S. Cl. 709/219

(57) ABSTRACT

The present invention relates to a method for selecting information in the Internet. The method allows to optimally select trustworthy information in the Internet. Furthermore, the method enables using said information in a shared website having a domain name. The method comprises using an Internet robot and performing a search in the Internet for information about subjects, whose means of identification contains a keyword corresponding to said domain name. Then, a request is sent through the Internet robot to e-mail addresses of the subjects revealed during a search. The request includes a proposal to publish data regarding these subjects on a shared website. The data includes means of identification of said subjects. The data are published on the shared website upon a receipt of a positive response to the proposal.

The method is realized by means of a computer server.

### CROSS-REFERENCE TO RELATED APPLICATION

This application claims the benefits from the International Application PCT/RU2010/000288 filed on May 26, 2010 and claiming priority from RU 2009121481 of May 27, 2009. The content of these applications is hereby incorporated by reference in its entirety.

### TECHNICAL FIELD

The present invention relates to methods and devices for processing data affecting the order or contents thereof. In particular, the present invention relates to methods for information selection in the Internet.

### BACKGROUND OF THE INVENTION

The Internet is a global telecommunications network linking computers and computer networks all over the world and forming the basis of the World Wide Web which is a system of interconnected documents. The Internet is often understood as the World Wide Web and various information available therein, and the amount of said information increases constantly. Databases and search engines are used to rank, search for, and select the information in the Internet.

Various methods for information selection in the Internet are known. US 20020078045 discloses a method for information selection is known, the method comprising searching the files corresponding to a user query by means of search engines and providing search results to the user, wherein the search results are ranked in accordance with a category associated with said user. In US 20020078045, the search results are ranked according to the user category, however, said results may not meet the user's expectations due to the nature of the query, because the query is set by the user, and in order to submit a correct query matching the user's interests, a certain level of skill and experience is required. For example, if the query is too broad, the search results can be very voluminous. Further, due to multiple meanings of words in the query, the search results also may not meet the user's expectations.

The aforementioned disadvantages are partially overcome in US 20040059708 which discloses a method for selecting information in the Internet, particularly relating to selecting advertisements, wherein it is determined whether an advertisement is relevant to a target document. In US 20040059708, the information is selected without using a query set by a user, which allows to eliminate the possibility of selecting information not meeting the search criteria through the user's fault. However, the method cannot always provide correct information selection due to the fact that the relevance of the information to the document is carried out by means of automatic processing, which does not eliminate possible errors when determining the topic of the document. Further, the method takes into account the nature of information being selected, which is advertisements in the Internet, and therefore, only the information available on certain websites owned by businesses funding the advertisement campaign can be selected.

US 20090063265 is the closest prior art and discloses a method for selecting information comprising choosing a plurality of internet websites to display hyperlinks thereof on the subscriber webpage by: analyzing the subscriber webpage to determine keywords characterizing the webpage contents, querying a search engine and a social bookmarks server with the keywords to provide resultant websites, and displaying hyperlinks to the plurality of chosen internet websites on the subscriber webpage.

US 20090063265 teaches performing search with use of not only search engines, but also of openly available servers allowing to store and publish website bookmarks. The bookmarks are hyperlinks to websites with a brief description thereof published by users, which provides a high chance of said description matching the required topic of the website. It allows to improve quality of information selection in comparison to other methods mentioned above.

However, US 20090063265 has several disadvantages. As in other methods, the information selected using search engines can have little in common with the query, which reduces the quality of selected information. One of the reasons thereof lies in unscrupulous actions of some website administrators that exploit the particular features of search engine operation (searching by keywords) in order to promote information contained on their websites. For example, they can use identifiers included in the code of e-documents and aimed at search engine indexing websites. These identifiers include a brief website description and a list of keywords characterizing its contents, and the identifiers are created by the website developer, and thus they are not objective. There are also websites with content including a list of keywords visible or invisible to the user, said list being used to promote the websites by means of search engines.

The above method for information selection and for using said information on a web page also has a disadvantage of placing only hyperlinks to selected websites on said webpage, which requires separate Internet websites providing selected information.

### BRIEF SUMMARY OF THE INVENTION

It is an object of the present invention to provide a method and a device for optimizing the selection of trustworthy information in the Internet according to an objective criterion, and using said information in a shared website irrespective of other websites related to the selected information.

The object is achieved by a method for selecting information in the Internet and using said information in a shared website having a domain name, the method comprising the following steps of:

compiling a list of keywords including at least one keyword corresponding to said domain name;

using an Internet robot, performing a search in the Internet for information about subjects, whose means of identification contains at least one keyword from said list;

recording in a file storage the information obtained as a result of said search, wherein said information includes at least data relating to said means of identification of subjects revealed as a result of the search, and contact data including e-mail addresses of said subjects;

using the Internet robot, sending a request to said e-mail addresses of the subjects, said request including a proposal to publish said information about said subjects on the shared website, and

upon receipt of a positive response to said proposal, publishing said recorded information on the shared website.

The search criterion is provided as a list of keywords corresponding to the domain name of the shared website; therefrom, the search criterion allows to select information including means of identification of subjects, wherein the means include a symbol sequence corresponding to said domain name, which symbol sequence actually matches the shared website because no correlation between topical content of said website and selected information is needed.

Further, the information is grouped in the Internet using the shared website with a domain name according to a unique criterion for the Internet, which criterion implies correspondence between information and said domain name, thus providing an easy search of information on the Internet. Using an Internet robot allows to automate the procedure and to reduce selection time, and due to objectivity of the search criterion, the errors made by the Internet robot (e.g. erroneous identification of keywords or topics) will be excluded from search results. The subject's consent to publish the information relating to them allows to publish only appropriate information that would correspond to the object of user-oriented information grouping in the Internet.

In one embodiment of the present invention, the list comprising at least one keyword includes a second-level domain name in the domain name of said shared website. Using a second-level domain as a keyword simplifies search regarding the subjects because a user can directly access websites, which domain name includes a part of means of individualization of said subjects. Thus, no use of search engines and databases is needed. Generally, a second-level domain name can be used to identify a website. In contrast, first-level domain names, or top-level domain names, cannot be used for such search because they broadly refer to an activity, such as .com or .info, or to a country, such as .uk or .de. It is contemplated that third-level domain names or fourth-level domain names are not suitable for such search either.

In another embodiment of the present invention, the subjects are selected from a group including natural persons and/or companies and/or organizations and/or businesses and/or associations and/or communities and/or groups. Selection of said subjects is objective because they usually have means of identification provided as a domain name.

In yet another embodiment of the present invention, when publishing said information in a shared website,

at least one separate web page, an e-mail address in the domain of said website and a sub-domain in the domain of said website are allocated for said information; and

a hyperlink to said allocated web page is placed on the main page of said website,

wherein said web page is designed in a way providing the content of the web page to be controlled by said subjects.

In this way, any information corresponding to said website and regarding the subjects can be published on the shared website, while said information can still remain unavailable through other Internet websites. The sub-domain allocated in the domain of the shared website can be similar to means of identification of said subjects, thus providing an easy search of information about said subjects on the Internet.

In yet another embodiment of the present invention, prior to recording, the information is validated using open Internet sources. Said validation enhances validity of the selected information.

In yet another embodiment of the present invention, a space for said recorded information is reserved on the shared website. This reduces time between selecting information about the subjects and publishing it on said website, taking into account that search can reveal much information, which can be published after receipt of the subjects' positive response.

Further, the object of the present invention is achieved by a computer server connected to the Internet and comprising at least

a processor,

a software, and

a file storage for storing files of a shared website having a domain name, wherein the said website is configured to store in the files of said website information obtained by selecting in the Internet and recording in the file storage using said software,

wherein said information includes data regarding subjects, whose means of identification includes at least one keyword corresponding to said domain name, said data including at least data relating to said the means of identification and contact data of said subjects, including e-mail addresses.

The software of said computer server further includes a software unit configured to check whether a condition for publishing the selected information on the shared website is fulfilled.

Said condition includes receipt of a positive response to a request sent to said subjects revealed during said search using their e-mail addresses, said request including a proposal to publish data regarding these subjects.

In one embodiment of the present invention, the file storage of the computer server contains files of the shared website, which has an interface optimized for viewing on mobile devices. Thus, said information is readily available not only through desktops or laptops, but also through mobile devices with Internet access.

In another embodiment of the present invention, the file storage of the computer server contains files of the shared website, which website is configured to allocate in the domain of said website an e-mail address to enable

interacting with said subjects;

forming a sub-domain in the domain of said website for said selected information;

forming at least one web page for publishing said selected information regarding the subjects, wherein said web page is adapted to control the contents thereof by said subjects; and

publishing on the main page of said shared website a hyperlink to said at least one web page, wherein the form of the hyperlink can be controlled by said subjects.

The computer server allows the users to use the shared website to view the information relevant to their interests, bypassing the preliminary step of using search engines and other search tools available on the Internet. Therefore, the shared website according to the present invention simplifies search and information analysis for users on the Internet, because the search and information analysis are done through said website.

In yet another embodiment of the present invention, the file storage of the computer server contains files of the shared website, which has an interface allowing users to select at least one web page containing information regarding at least one subject of interest,

wherein the software further includes a software unit adapted to recognize said selection during subsequent visits of the shared website by the users who made said selection and who use a software allowing to view websites, by transmitting to said software a command to switch from the main page of the shared website directly to the at least one previously selected web page of the shared website.

The shared website interface also allows the users to cancel said selection.

Said computer server provides operation of the shared website having an interface that simplifies said website navigation by optimizing access to the information grouped on the shared website, said optimization including reducing the time it takes the users of said website to access the information published on said website.

### BRIEF DESCRIPTION OF THE DRAWINGS

FIG. 1 is a flowchart illustrating the method for selecting information in the Internet and using said information in a shared website according to the present invention.

FIG. 2 is a scheme illustrating the actions of administrators, participants and users of the shared website, with files thereof stored in the file storage of the computer server of the present invention.

### DETAILED DESCRIPTION OF THE INVENTION

Herein, a “shared website” is a site in the Internet used for publishing information corresponding thereto based on a certain criterion regarding more than one subject interested in said publishing. In this case, the domain, i.e. the area of hierarchical space of Internet domain names denoted by a unique domain name, of the shared website is called a shared domain, because it can be stated that said domain is “shared” by subjects for Internet search optimization of information regarding said subjects, said information published on the shared website with such domain.

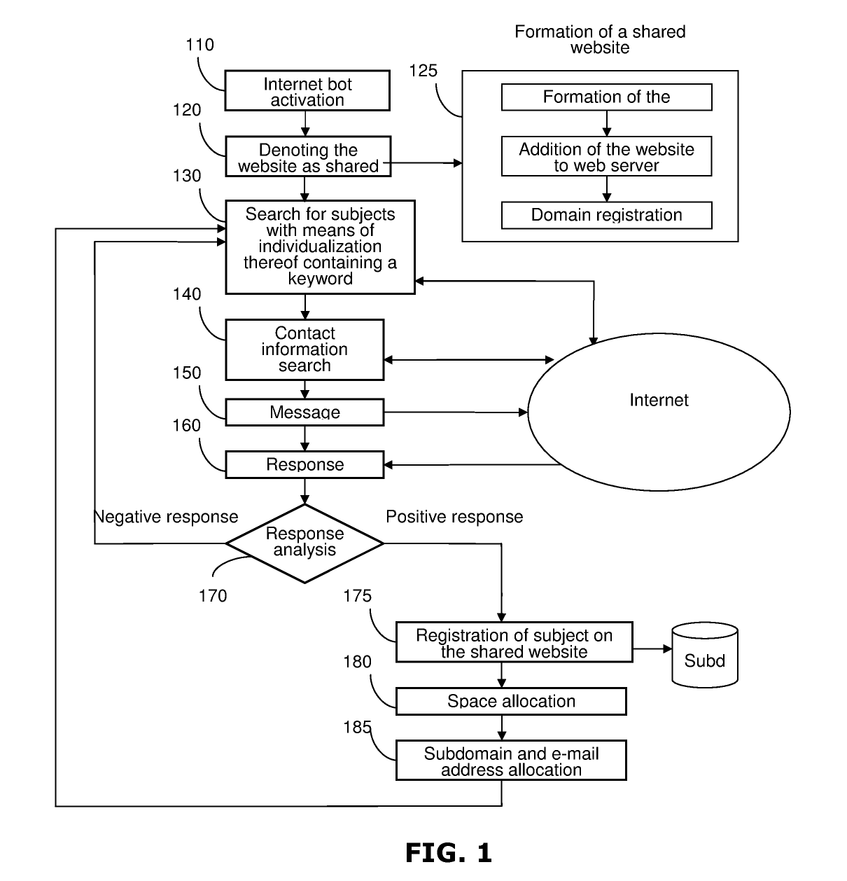

The method of the present invention is realized by the website owner having a domain name that presents a potential interest for others, or by people contracted by said owner, as follows (see FIG. 1). First, at step 110, an Internet robot is activated to automatically perform operations at subsequent steps. Said Internet robot can be adapted to work in a semi-automatic mode, wherein it performs only a portion of operations, or actions thereof are corrected based on the results of operation thereof. At step 120, the website is declared “shared”, and the interface and domain corresponding to said website are set up. Said domain can be assigned a “shared domain” status, which is shown when viewing the domain information, e.g. by using a WHOIS protocol that can be utilized to obtain the registration data of the domain name owner. The shared website can also be formed specifically, which is carried out at step 125, wherein the website is created, the website files are recorded in the file storage of the web server, which is a computer server connected to the Internet, and the domain name for said website is registered, while performing the setup procedures necessary to denote that the created website is shared.

At step 130, an Internet search for information about subjects whose means of identification include a keyword corresponding to the second-level domain in the domain name of the shared website is performed. Subjects include companies, organizations, businesses, associations, communities, groups and natural persons. Means of identification include, but are not limited to, brand names, commercial designations, domain names, names of non-profit organisations.

For example, in case of an existing shared website with the domain name “protectors.com”, the keyword “protectors” corresponding to the second-level domain name was used, and in the search results, the information regarding the companies Life Protectors Company Inc., American Protectors Inc., Book Protectors & Company, The Protectors Group and non-profit organisations Animal Protectors, The Protectors, among others, was selected, said information including names of said companies and organizations, as well as the description and the contact information thereof.

When searching for information, the Internet robot can utilize own search algorithms and query search engines, registers and databases of the Internet. The Internet robot can also analyze, based on a preset algorithm, existing domain names when determining websites that can be denoted as shared. In this case, the Internet robot sends an e-mail to the owners or administrators of such websites, including information regarding the possibility of denoting said websites as shared.

Then, at step 140, a search for the contact information of the found subject is performed, and the obtained information is validated using available Internet sources. At step 150, the subject is sent a request, e.g. via e-mail, containing a proposal to publish the information regarding said subject on the shared website, and a space for said information is reserved on said website by analyzing the location of previously published information and selecting the most advantageous location for said information on the main page of the shared website according to a preset algorithm. Upon receiving the response to said proposal at step 160, said response is analyzed at step 170. If the response is negative, the process moves back to step 130. If the response is positive, the new participant is registered (step 175), whereupon all required information is recorded in the database, then a space for the information regarding said participant is allocated (step 180), and a sub-domain and an e-mail address is allocated for said participant in the domain of the shared website (step 185). A sub-domain is a lower-level domain with respect to a certain domain, i.e. a sub-domain is a domain that is one or more levels lower than a certain domain. For example, in case of the shared domain “protectors.com”, a sub-domain “book.protectors.com” can be allocated to the Book Protectors & Company organization.

Therefore, a shared website groups the information in the Internet based on an objective criterion: the presence of the domain name of the shared website in the means of identification (e.g. in the name) of the subject (e.g. a company). Said subject does not necessarily have to possess an individual website on the Internet in order for the information thereabout to be selected (the information can, for example, be included only in the Internet databases similar to phonebooks and Yellow Pages). By means of the shared website, the subject receives an individual web page, an e-mail address and a domain name, based on which the information in the Internet regarding said subject can be found without using search engines, by simply entering the website address containing a part of the name of the object of interest.

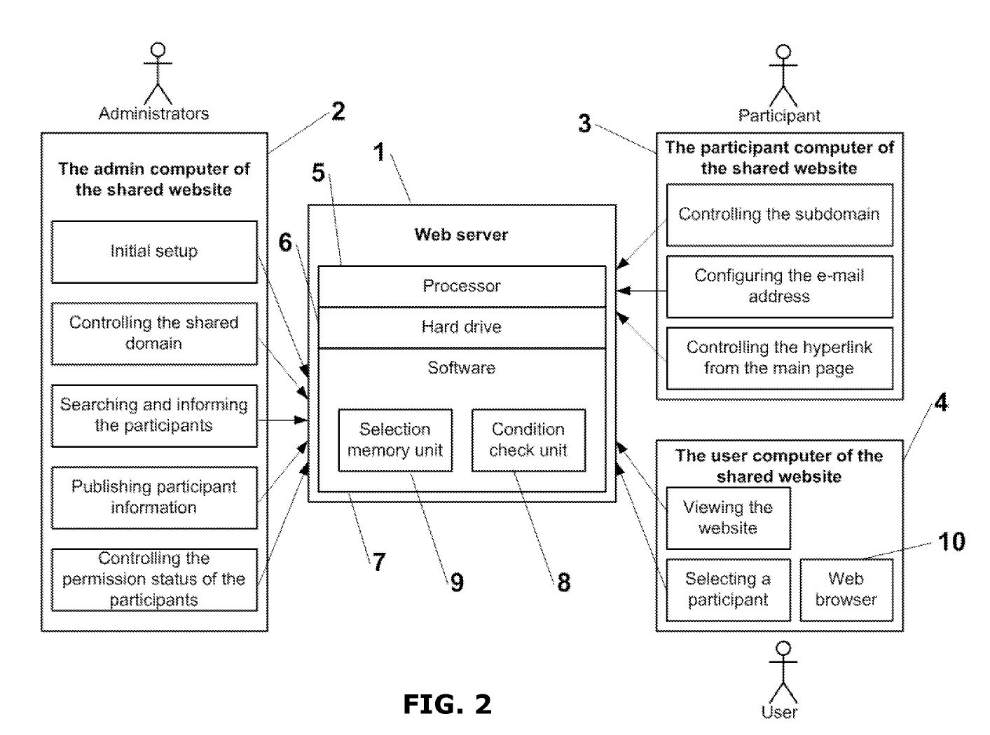

The actions of administrators, participants and users of the shared website are shown in FIG. 2, illustrating the web server 1, which is a computer server of the present invention connected to the Internet and comprising a processor 5, a hard drive 6, which is a file storage containing files of the shared website, and software 7. The administrators of the shared website, by means of the computer 2 connected to the Internet or by means of software 7 of the web server 1, perform the initial setup of said website, including creating an interface of said website, and perform the control function over the shared domain, including creating sub-domains and changing domain name settings. By means of software 7, the administrators can perform an Internet search for information regarding the subjects and inform said subjects about the possibility of publishing the information regarding said subjects on the shared website. Only if a positive response from the subjects is received, the software unit 8 of software 7 allows to assign the shared website participant status to said subjects and to publish the information regarding said subjects on said website. The administrators control the permission status of the participants by publishing hyperlinks to web pages created for publishing the information about the participants for said page on the main page of the shared website, said web pages are stored in the form of files on the hard drive 6; and by allocating e-mail addresses and sub-domains in the domain of said website to the participants.

Each participant of the shared website can control the subdomain allocated thereto via a computer 3 connected to the Internet by publishing any information thereabout on web pages corresponding to said subdomain, and by controlling the design of said pages. Each participant is also provided with the possibility to configure their e-mail address, which may include changing settings and passwords and mail redirection, and to control the hyperlink to the pages allocated thereto from the main page of the shared website by selecting the design thereof, e.g. in case of a graphical hyperlink, the participant chooses an image for said hyperlink.

Each user of the shared website can search for and view information published on said website using the interface of the shared website by means of a computer 4 connected to the internet and having a web browser 10 installed; said web browser is a software program allowing, among other things, to view websites. The interface of the shared website also allows the user to bookmark the participant of interest, wherein a special cookie file, containing user settings data used by web browsers, can be saved in the user computer 4. During subsequent visits to the shared website, the web server 1, by means of the software unit 9 that uses the cookie file, will redirect the web browser 10 of the user who previously bookmarked a participant of said website to the web page of said participant. The interface of the shared website allows to reset said user settings, thus said redirection will not be executed. Said interface also provides the possibility for the user to get registered on the shared website, whereupon said redirection will be executed after the user is signed in.

If the user computer 4 is a mobile device, e.g. mobile phone, smartphone, PDA, pocket computer or netbook, the shared website can be provided with an option of switching to an auxiliary interface configured for viewing on mobile devices.

Even though the present invention is disclosed above by means of the embodiments, the scope of the present invention is not limited to said embodiments, and is defined only by the appended claims taking into account possible equivalents.

I claim:

1. A method for selecting information in the Internet and using said information in a shared website having a domain name, the method comprising the steps of:
compiling a list of keywords including at least one keyword corresponding to said domain name,
using an Internet robot, performing a search in the Internet for information about subject(s), whose means of identification contains at least one keyword from said list,
recording in a file storage the information obtained as a result of said search, wherein said information includes at least data relating to said means of identification of said subjects, revealed as a result of the search, and contact data including e-mail addresses of said subjects,
using the Internet robot, sending a request to said e-mail addresses of the subjects, said request including a proposal to publish said information about said subjects on the shared website, and
upon receipt of a positive response to said proposal, publishing said recorded information on the shared website.

2. A method according to claim 1, wherein said list comprising at least one keyword includes a second-level domain name in the domain name of said shared website.

3. A method according to claim 1, wherein the subjects are selected from a group including natural persons and/or companies and/or organizations and/or businesses and/or associations and/or communities and/or groups.

4. A method according to claim 1, wherein, when publishing the information in a shared website,
at least one separate web page, an e-mail address in the domain of said website and a sub-domain in the domain of said website are allocated for said information, and
a hyperlink to said web page is placed on the main page of said website,
wherein said web page is designed in a way providing the content of the web page to be controlled by said subjects.

5. A method according to claim 1, wherein, prior to recording, the information is validated using open Internet sources.

6. A method according to claim 1, wherein a space for said recorded information is reserved on the shared website.

7. A computer server connected to the Internet for selecting information in the Internet and comprising at least
a processor,
a software, and
a file storage for storing files of a shared website having a domain name, wherein the said website is configured to store in the files of said website information obtained by selecting in the Internet and recording in the file storage using said software,
wherein said information includes data regarding subjects, whose means of identification includes at least one keyword corresponding to said domain name, said data including at least data relating to said means of identification and contact data of said subjects, including e-mail addresses,
wherein said software further includes a software unit configured to check whether a condition for publishing the selected information on the shared website is fulfilled,
wherein said condition includes receipt of a positive response to a request sent to said subjects revealed during a search using their e-mail addresses, said request including a proposal to publish data regarding these subjects.

8. A server according to claim 7, wherein the file storage contains files of the shared website, which has an interface optimized for viewing on mobile devices.

9. A server according to claim 7, wherein the file storage contains files of the shared website, which website is configured to allocate in the domain of said shared website an e-mail address to enable
interacting with said subjects;
forming a sub-domain in the domain of said website for said selected information;
forming at least one web page for publishing said selected information regarding the subjects, wherein said web page is adapted to control the contents thereof by said subjects; and
publishing on the main page of said shared website a hyperlink to said at least one web page, wherein the form of the hyperlink can be controlled by said subjects.

10. A server according to claim 9, wherein the file storage contains files of the shared website, which has an interface allowing users to select at least one web page containing information regarding at least one subject of interest,
wherein the software further includes a software unit adapted to recognize said selection during subsequent visits of the shared website by the users who made said selection and who use a software allowing to view websites, by transmitting to said software a command to switch from the main page of the shared website directly to the at least one previously selected web page of the shared website,
wherein said interface also allows the users to cancel said selection.
